(19) United States
(12) Patent Application Publication
(10) Pub. No.: US 2026/0244737 A1
(43) Pub. Date: Aug. 20, 2026

(54) Information Processing Apparatus

(71) Applicant: Hitachi Astemo, Ltd., Hitachinaka-shi, Ibaraki (JP)

(72) Inventors: Shinya SASA, Tokyo (JP); Kota IDEGUCHI, Tokyo (JP); Takashi YAMAGUCHI, Tokyo (JP); Yasuhiro FUJII, Tokyo (JP)

(21) Appl. No.: 18/993,071

(22) PCT Filed: May 23, 2023
(86) PCT No.: PCT/JP2023/019151

§ 371 Date: Jan. 10, 2025

(30) Foreign Application Priority Data
Jul. 20, 2022 (JP) 2022-115422

(51) Int. Cl. G06F 21/55

(52) U.S. Cl. CPC G06F 21/554

(57) ABSTRACT

An information processing apparatus includes an alert acquiring section that acquires alert information, a component extracting section that extracts a software component for which a countermeasure is necessary, on the basis of the alert information, a notification destination identifying section that identifies notification information including information about an organization that is capable of implementing the countermeasure for the software component, a reliability setting section that sets reliability of the notification information, and a notifying section that notifies the organization of the software component in a case where the reliability is equal to or higher than a predetermined threshold.

### TECHNICAL FIELD

The present invention relates to an information processing apparatus and, in particular, relates to an information processing apparatus that identifies software components that are causes of an alert when the alert has occurred and can promptly implement countermeasures.

### BACKGROUND ART

While the trend of IoT that makes everything connected to the Internet is underway, ensuring the security of IoT equipment is one of important social issues. In particular, in a case where IoT equipment is such automobiles as connected cars or automated driving vehicles, the safety of humans is threatened in some cases when an automobile is under a security-related attack, and technologies that reduce such safety-related damage to the minimum are demanded.

For this purpose, in recent years, a Vehicle Security Operation Center (VSOC: Vehicle Security Operation Center) has been examined for managing security during operational use after vehicles are shipped. In the VSOC, alerts representing the occurrence of incidents need to be handled within the company until software components that are causes of the incidents are corrected. For this identification and correction of causes, information needs to be shared with organizations in charge such as development departments or suppliers, and requests for investigation/handling need to be made appropriately.

However, a great amount of man-hours is required for choosing an organization in charge for each piece of software and accurately sharing information that the organization needs. In addition, the number of connected cars is ever increasing, and the number of vehicles monitored by the VSOC will be become large. Then, it is considered that methods for attacking automobiles also will become diverse. In such an environment, in a case where new alerts are detected, analysis takes time, and work load of operators and analysts increases, undesirably.

Patent Document 1 discloses a system in which a problem-related report such as a bug report about software is received and a report related to a problem is sent from a corresponding developer organization to a registered software developer.

### PRIOR ART DOCUMENT

### Patent Document

Patent Document 1: JP-2016-173844-A

### SUMMARY OF THE INVENTION

### Problems to be Solved by the Invention

However, the technology disclosed in Patent Document 1 cannot cope with correction of report content, checking of reliability, and handling of information about feedback from report destinations, and it still cannot sufficiently reduce work load of operators and analysts.

The present invention has been made in view of the matters described above, and an object thereof is to provide an information processing apparatus for promptly identifying software components which are causes of an incident and organizations in charge in a case where the incident has occurred, and for promptly implementing incident countermeasures.

### Means for Solving the Problems

An example of an information processing apparatus according to the present invention includes an alert acquiring section that acquires alert information, a component extracting section that extracts a software component for which a countermeasure is necessary, on the basis of the alert information, a notification destination identifying section that identifies an organization which is capable of implementing the countermeasure for the software component and that decides notification information of which the organization is to be notified, a reliability setting section that sets reliability of the notification information, and a notifying section that notifies the organization of the software component in a case where the reliability is equal to or higher than a predetermined threshold.

### ADVANTAGES OF THE INVENTION

The present invention makes it possible to promptly identify software components which are causes of an incident and organizations in charge in a case where the incident has occurred, and to promptly implement incident countermeasures.

Further features related to the present invention are made clear by the description and attached figures of the present specification. In addition, problems, configurations, and advantages other than those described above are made clear by the following explanation of an embodiment.

### BRIEF DESCRIPTION OF THE DRAWINGS

FIG. 1 is a functional block diagram representing a functional configuration of an information processing apparatus according to an embodiment of the present invention.

FIG. 2 is a figure depicting a summary of an overall process executed by the information processing apparatus according to the embodiment of the present invention in cooperation with external entities in a case where an alert is received.

FIG. 3 is a figure depicting a process performed by a mapping section to generate a mapped alert.

FIG. 4 is a figure depicting a process performed by a component extracting section to generate a component-extracted alert.

FIG. 5 is a figure depicting a process performed by a notification destination identifying section to generate notification information.

FIG. 6 is a figure depicting a process performed by a reliability setting section to generate reliability-set notification information.

FIG. 7 is a figure depicting a flow of a process implemented by a notifying section on the reliability-set notification information.

FIG. 8 is a figure depicting a process performed by a DB updating section to update each database.

### MODE FOR CARRYING OUT THE INVENTION

Hereinafter, an embodiment of the present invention is explained in detail using an embodiment and with reference to the figures.

First, a functional configuration of an information processing apparatus 1 according to an embodiment of the present invention is explained. Note that, for example, the information processing apparatus 1 may be a computer having a hardware configuration including a memory and a processor or may be realized using a cloud implemented on a server.

The information processing apparatus 1 includes an alert acquiring section 11, a mapping section 12, a component extracting section 13, a notification destination identifying section 14, a reliability setting section 15, a notifying section 16, a feedback reflecting section 17, a DB (database) updating section 18, and a storage section 100. In addition, an alert threat DB 101, a countermeasure DB 102, a countermeasure software DB 103, an organization-in-charge DB 104, and a feedback DB 105 are stored on the storage section 100. Details of these functional sections and databases are described later.

In addition, the information processing apparatus 1 is connected to a plurality of external entities 3 via a communication path 2 connected to an unillustrated communication interface of the information processing apparatus 1. The communication path 2 may physically include a plurality of communication buses, and the standards of the respective communication buses may all be identical or different. The external entities 3 receive messages from the information processing apparatus 1 via the communication path 2, and transmit messages to the information processing apparatus 1 via the communication path 2. Note that, in the present embodiment, “external entities” mean external/internal organizations that exchange information with the information processing apparatus 1 described later and that include external/internal systems including SIEM, PSIRT analysts, and the like.

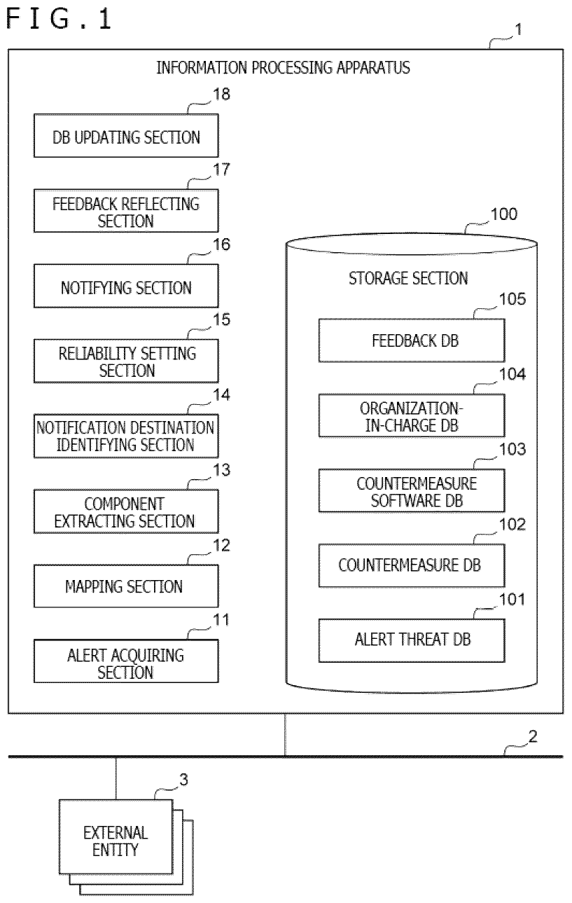

The functional block diagram depicted in FIG. 1 illustrates an example, and units and names of functions are not limited to those depicted in FIG. 1. For example, in the present embodiment, a function realized by the component extracting section 13 may be realized by another functional section depicted in FIG. 1, or may be realized by a functional section not depicted in FIG. 1. In addition, the alert acquiring section 11 may have functions of the communication interface described above.

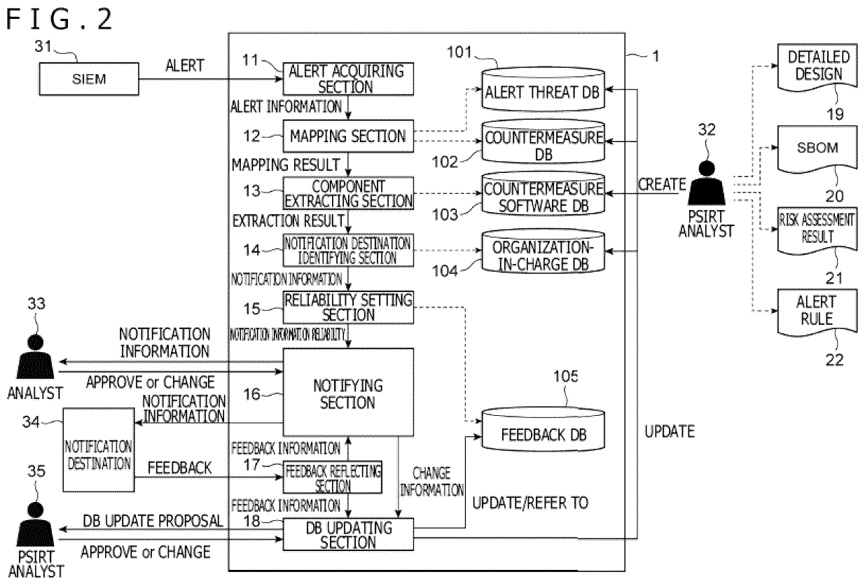

FIG. 2 is a figure depicting a summary of an overall process executed by the information processing apparatus according to the embodiment of the present invention in cooperation with external entities in a case where an alert is received. Here, the alert is a warning representing the occurrence of an incident or a possibility of the occurrence of the incident, and, for example, the incident means some trouble that occurs to electronic equipment mounted on a vehicle, such as a trouble that causes the electronic equipment to malfunction or that prevents the electronic equipment from being activated. Note that, in the figures, dotted-line arrows represent information reference to respective databases which are data sets stored on hardware such as a memory or on software in the cloud, and solid-line arrows represent information transmission.

The process depicted in FIG. 2 is a process executed by a CPU while each functional section in the information processing apparatus 1 refers to each database in the storage section 100. Here, information in the alert threat DB 101, the countermeasure DB 102, the countermeasure software DB 103, and the organization-in-charge DB 104 among the databases has been generated by a PSIRT analyst 32 in advance.

The PSIRT described above is an abbreviation of Product Security Incident Response Team, and refers to an organization that enhances the security level of a product or a service manufactured/developed by the company and handles the occurrence of an incident of the product or the service. That is, the PSIRT recognizes, in detail, errors that can occur to products (equipment/software components, etc.) that can cause an incident and countermeasures or the like for the errors. The PSIRT can organize/construct the errors and the countermeasures in a database-like manner.

The PSIRT analyst 32 can create the databases described above by referring as appropriate to a detailed design (specifications) 19 of each product, an SBOM (Software Bill of Materials) 20 representing the specifications of a software component, results 21 of a risk assessment implemented for each product, and rules 22 about generation of alerts.

Next, a process to be implemented with reference to these databases is explained. When an alert is issued from any piece of equipment or the like, the alert is transmitted from the SIEM 31, which is one of the external entities 3, to the alert acquiring section 11 of the information processing apparatus 1. Here, the SIEM is an abbreviation of Security Information and Event Management, and refers to a security product that centrally manages/analyzes logs of every piece of IT equipment including network products and security products and detects threats that lead to incidents.

When the alert acquiring section 11 acquires the alert, the alert is transferred to the mapping section 12. The mapping section 12 performs mapping by associating a threat ID and a countermeasure ID with the alert with reference to the alert threat DB 101 and the countermeasure DB 102. A mapping result is transferred to the component extracting section 13.

Upon receiving the mapping result, the component extracting section 13 extracts a software component related to the countermeasure ID by referring to the countermeasure software DB 103. An extraction result is transferred to the notification destination identifying section 14.

By referring to the organization-in-charge DB 104, the notification destination identifying section 14 identifies an organization that is capable of implementing a countermeasure for the extracted software component, and also decides information to be notified to the organization. Then, notification information including the organization selected as a result of the identification and content to be notified is generated. The notification information is transferred to the reliability setting section 15.

The reliability setting section 15 sets reliability for the received notification information by referring to the feedback DB 105. Here, the reliability means a probability representing whether or not the notification destination and the notification content included in the notification information correspond correctly to the alert acquired by the alert acquiring section 11. The notification information for which the reliability is set is transferred to the notifying section 16.

The notifying section 16 compares the reliability of the received notification information with a predetermined threshold. In a case where the reliability is equal to or higher than the predetermined threshold, the notification information is transferred as it is to the notification-destination organization. In a case where the reliability is lower than the predetermined threshold, the notification information is transmitted to an analyst 33, which is one of the external entities 3. Here, the analyst 33 refers to an expert (expert analysis organization) who typically monitors, senses, analyzes, and handles cybersecurity incidents 24 hours a day, 365 days a year. The analyst 33 analyzes notification information with low reliability, and, if it is determined that the notification information corresponds correctly to an alert, the analyst 33 approves the notification information, and transmits it to the notifying section 16. If the notification information does not correspond correctly to the alert, the analyst 33 changes/corrects the notification information to information corresponding correctly to the alert, and transmits it to the notifying section 16.

Then, the notifying section 16 transmits the approved/changed notification information received from the analyst 33 as notification information to a notification destination 34. In addition, in a case where the notification information received from the analyst 33 has been changed, change information is transferred to a DB updating section 18.

Upon receiving the notification information from the notifying section 16, the notification destination 34 finally decides whether the notification information corresponds correctly to the alert. Then, results of the decision are transmitted to the feedback reflecting section 17.

The feedback reflecting section 17 transfers the feedback information received from the notification destination 34 to the notifying section 16 and the DB updating section 18. That is, this feedback accurately represents whether or not the notification information that the notifying section 16 has transmitted to the notification destination 34 corresponds correctly to the alert.

The notifying section 16 having received the feedback information corrects the notification information. The DB updating section 18 stores, in the feedback DB 105, the received change information and feedback information.

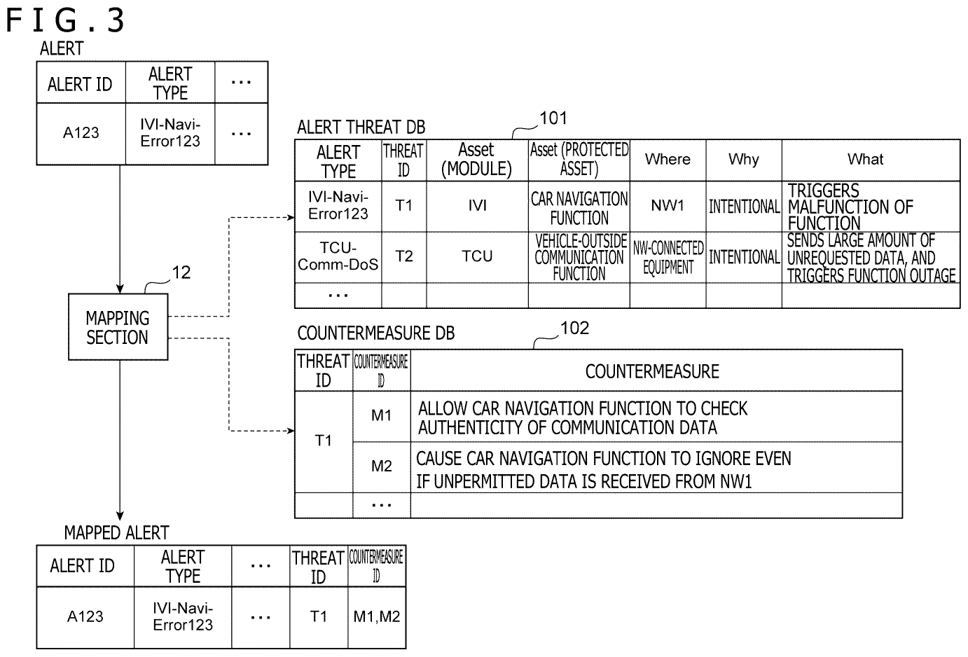

Next, further details of processes executed by each functional section are explained using FIGS. 3 to 8.

FIG. 3 is a figure depicting details of a process performed by the mapping section 12 to generate a mapped alert. The alert threat DB 101 is a database that stores information about threats related to issued alerts (attack-target modules, attack-target protected assets, attackers, reasons for attacks, threat events). The countermeasure DB 102 is a database that stores a list of countermeasures that should be taken against respective ones of threats stored in the alert threat DB.

First, it is assumed that the alert type of an alert transferred from the alert acquiring section 11 is IVI-Navi-Error123, and that the alert ID associated with the alert is A123.

By referring to the alert threat DB 101, the mapping section 12 searches for a threat related to the received alert. In the present embodiment, it can be known from the alert threat DB 101 depicted in FIG. 3 that the received alert is related to a threat with a threat ID: T1 that intentionally triggers a malfunction of a function from a NW (NetWork) 1 in a car navigation function in an IVI (In-Vehicle Infotainment system).

Further, with reference to the countermeasure DB 102, a countermeasure that should be implemented against the threat ID: T1 is searched for. In the present embodiment, it can be known that two types of countermeasure associated with countermeasure IDs: M1 and M2 are set for the threat ID: T1.

On the basis of the process described above, the mapping section 12 generates a mapped alert in which the threat ID and the countermeasure IDs are associated with the alert, and transfers the mapped alert to the component extracting section 13.

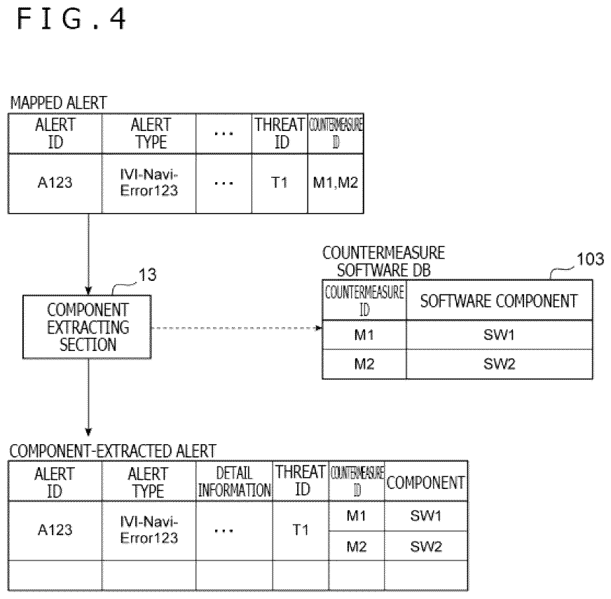

FIG. 4 is a figure depicting a process implemented by the component extracting section 13 having received the mapped alert from the mapping section 12 to generate a component extracted alert. Software components corresponding to respective countermeasures stored in the countermeasure DB 102 are stored in the countermeasure software DB 103. That is, software components that can implement countermeasures are stored.

By referring to the countermeasure software DB 103, the component extracting section 13 having received the mapped alert searches for software components corresponding to the countermeasure IDs associated with the mapped alert. In the present embodiment, it can be known that a software component SWI corresponds to countermeasure content associated with the countermeasure ID: M1, and that a software component SW2 corresponds to countermeasure content associated with the countermeasure ID: M2.

Further, the component extracting section 13 associates component information with the mapped alert, and generates a component-extracted alert. The generated component-extracted alert is transferred to the notification destination identifying section 14.

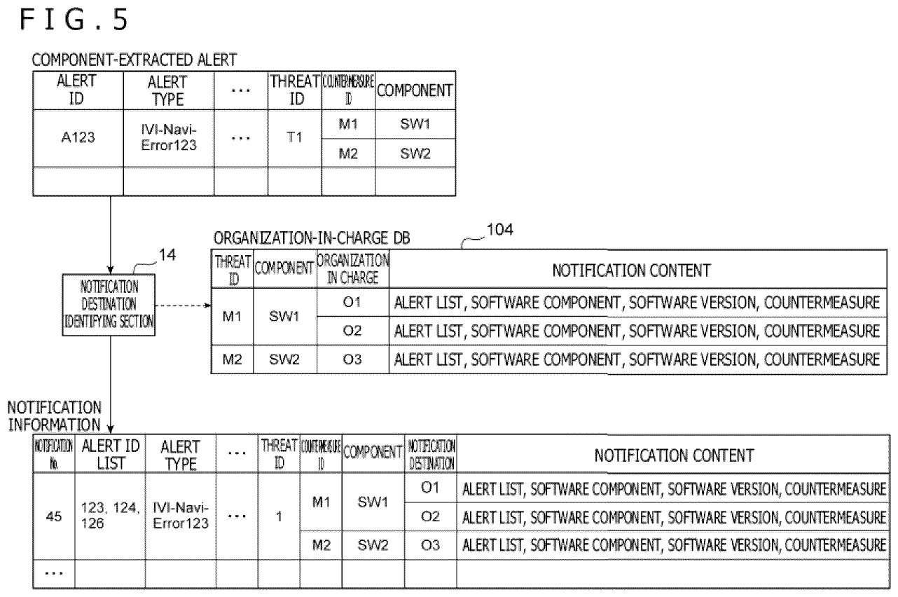

FIG. 5 is a figure depicting a process implemented by the notification destination identifying section 14 having received the component-extracted alert from the component extracting section 13 to generate notification information. Organizations associated with respective ones of software components stored in the countermeasure software DB 103 are stored in the organization-in-charge DB 104. Examples of the organizations associated with the software components include, for example, a department that has developed the software components and a department in charge of maintenance in a case where the organizations are those within the company. In addition, in a case where the organizations are those within a different company, the examples include departments in charge in the different company. The number of the organizations is not limited to one, and, for example, in a case where a software component has been jointly developed or in a case where development and maintenance of a software component are performed by separate organizations, the number of the organizations can be greater than one. In addition, the content of information of which the organizations should be notified is also stored in the organization-in-charge DB 104. The number of pieces of the notification content can also be greater than one depending on the roles of the organizations, for example, as with the above.

By referring to the organization-in-charge DB 104, the notification destination identifying section 14 searches for an organization related to each of the software components. In the present embodiment, it can be known that, regarding the software component SW1, organizations O1 and O2 should be notified of depicted corresponding notification content and that, regarding the software component SW2, an organization O3 should be notified of depicted corresponding notification content.

By the process described above, the notification destination identifying section 14 associates the notification destination and the notification content with alert content, and generates notification information. Note that, as depicted in FIG. 5, alerts of identical alert types may be put together into one notification. The generated notification information is transferred to the reliability setting section 15.

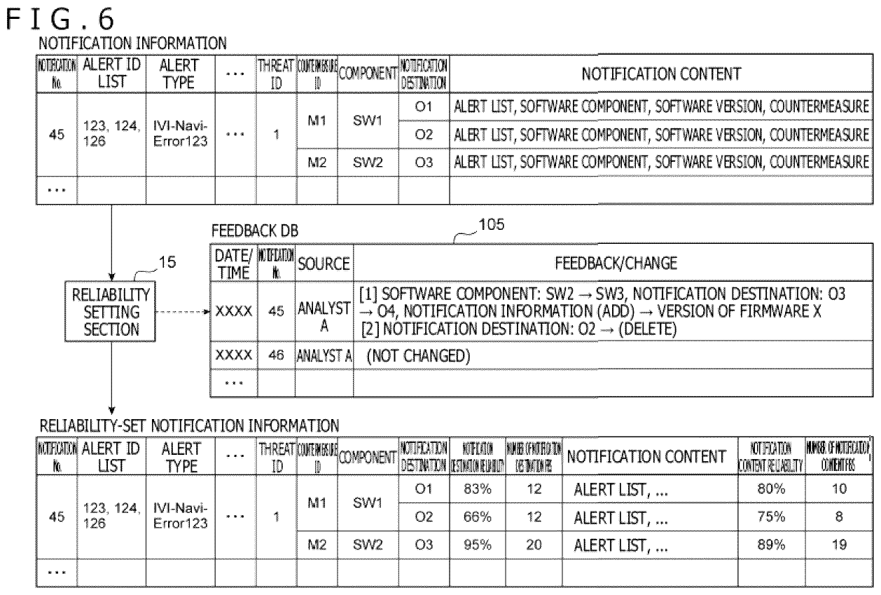

FIG. 6 is a figure depicting a process implemented by the reliability setting section 15 having received the notification information from the notification destination identifying section 14 to generate reliability-set notification information. The feedback DB 105 is a database that stores change information and feedback information obtained through a series of processing implemented until then. All pieces of alert information having notification numbers have alert types, countermeasure IDs, extracted software components, notification destinations, and notification content. After a series of processing is implemented, as explained in the processing summary with reference to FIG. 2, feedback is obtained from the analyst 33 or the notification destination 34. That is, feedback as to whether or not notification information generated by the notifying section 16 is correct in the end is stored.

By referring to the feedback DB 105, the reliability setting section 15 sets reliability of the notification information. Specifically, in the case of notification information with a notification No. 45 in FIG. 6, a threat ID: 1 and the countermeasure ID: M1 are set, and additionally in a case where an extracted software component is SW1, O1 is set as one of notification destinations. In this case, it is depicted that, in the feedback DB 105, 12 similar notifications are stored, and that O1 was the correct notification destination in 83% of the notifications, that is, in ten notifications. Similarly, it is depicted that, regarding cases where O2 was a notification destination, O2 was the correct notification destination in 66% of 12 cases, that is, eight cases. In other words, it is depicted that O2 was not the correct notification destination in four cases out of the 12 cases.

Similarly, also regarding the notification content, the notification is collated with feedback accumulated in the feedback DB 105, and reliability representing how many pieces of notification content were correct is set. In this manner, the reliability setting section 15 generates the reliability-set notification information. The generated reliability-set notification information is transferred to the notifying section 16.

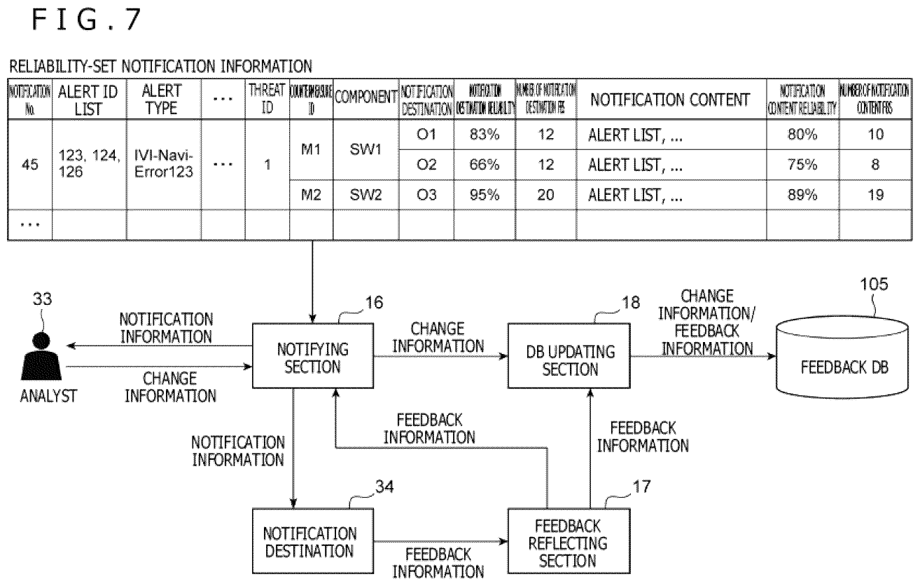

FIG. 7 is a figure depicting a process implemented by the notifying section 16 having received the reliability-set notification information from the reliability setting section 15.

The notifying section 16 having received the reliability-set notification information identifies the reliability of the notification destination and the notification content included in the notification information. Here, the notifying section 16 has stored thereon a threshold related to reliability. In a case where the reliability of either the notification destination or the notification content is lower than the threshold, the notifying section 16 determines that the possibility that the notification destination or the notification content is wrong is relatively high, and transmits the notification information to the analyst (analysis organization) 33 for detailed analysis. In a case where the reliability is equal to or higher than the threshold, it is determined that detailed analysis is not necessary, and the notification information is directly transmitted to the notification destination (organization that is capable of implementing a countermeasure) 34. For example, the threshold related to the reliability can be set as appropriate to 75% regarding the reliability, five regarding the numbers of feedbacks. The threshold may be different for each alert type, and may be updated on a daily basis.

In this manner, in the present embodiment, by setting the reliability for notification information, in a case where the reliability of the notification information is relatively high, detailed analysis by the analyst can be omitted, and the notification information can be directly transmitted to a notification destination. Accordingly, it becomes possible to promptly share the alert content, and it becomes possible to significantly reduce time required for implementing countermeasures in response to an alert.

When the reliability of notification information is low and the notification information is transmitted to the analyst 33, the analyst 33 analyzes the notification information in detail. In a case where there is a portion to which a change should be made, the analyst 33 replies to the notifying section 16 with change information including content to which the change has been made. The notifying section 16 having received the change information corrects the notification information on the basis of the change information, and transmits the notification information to the notification destination 34. Simultaneously, the change information is transmitted to the DB updating section 18.

The notification destination 34 having received the notification information makes a final determination as to whether or not the notification information is correct, and transmits the final determination as feedback information to the feedback reflecting section 17. On the basis of the received feedback information, the feedback reflecting section 17 generates final feedback information, and transmits the final feedback information to the notifying section 16 and the DB updating section 18.

Note that the notifying section 16 may notify the notification destination 34 not only of the notification information described above but also of information about software components and a notifier of countermeasure information included in the notification information. It becomes possible for the notification destination 34 to enhance analysis precision by using those pieces of information.

The DB updating section 18 stores, in the feedback DB 105, the received change information and feedback information. A reason for storing both the change information and the feedback information is because the change information is content of changes made as a result of analysis by the analyst 33, the feedback information is final feedback given from the notification destination 34, and accordingly, enhancement of the precision of the analysis by the analyst can be expected by making differences between the change information and the feedback information clear.

In this manner, according to the present embodiment, databases keep being updated on the basis of final feedback about initially-generated notification information, the final feedback being obtained from destinations of transmission. Accordingly, enhancement of the precision of initial information to be generated at the time when alerts are issued can be expected.

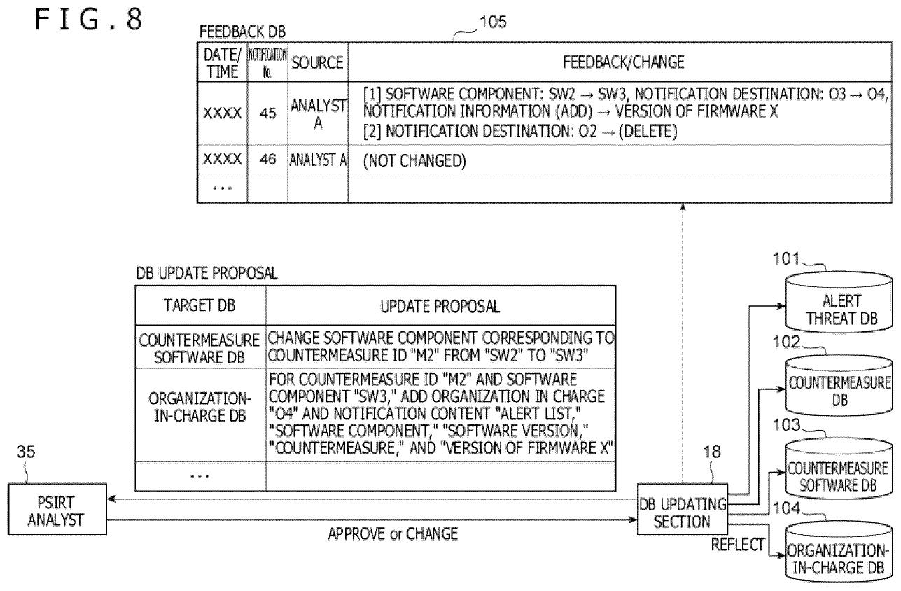

FIG. 8 is a figure depicting a process implemented by the DB updating section 18 to update each database. The DB updating section 18 compares the final feedback information received from the notification destination 34 and information stored in the databases before the process, and generates a proposal regarding databases that should be updated and content of the updating.

In the present embodiment, for example, regarding notification information about the notification No. 45 depicted in FIG. 7 and the like, the countermeasure software DB 103 at the time of notification information generation has stored information that the software component SW2 corresponds to the countermeasure ID: M2; however, it is determined that this is wrong information, and that correct information is that a software component SW3 corresponds to the countermeasure ID: M2, and this change is included as a proposal. In addition, along with updating of the countermeasure software DB 103, also regarding the organization-in-charge DB 104, a proposal includes changes to an organization in charge and notification content corresponding to the software component SW3.

The DB updating section 18 transmits, to a PSIRT analyst 35, the DB update proposal obtained by the process described above, and requests an approval thereof or further changes. Then, each database is updated using, as a final proposal, an update proposal transmitted as a reply from the PSIRT analyst 35.

In this manner, each database keeps being updated on the basis of obtained feedback information. Accordingly, it becomes possible to enhance the precision of notification information generation, notification information that requires detailed analysis by analysts is reduced, and reduction of time required for sharing information and implementing countermeasures can be expected.

The embodiment of the present invention explained above achieves the following effects and advantages.

(1) An information processing apparatus according to an embodiment of the present invention includes an alert acquiring section that acquires alert information, a component extracting section that extracts a software component for which a countermeasure is necessary, on the basis of the alert information, a notification destination identifying section that identifies an organization which is capable of implementing the countermeasure for the software component and that decides notification information of which the organization is to be notified, a reliability setting section that sets reliability of the notification information, and a notifying section that notifies the organization of the software component in a case where the reliability is equal to or higher than a predetermined threshold.

The configuration described above makes it possible to promptly identify software components which are causes of an incident and organizations in charge in a case where the incident has occurred, and to promptly implement incident countermeasures.

(2) The information processing apparatus further includes a mapping section that associates, with the alert information, threat information representing information about a threat related to the alert information and countermeasure information corresponding to the threat information, and the component extracting section extracts the software component on the basis of a result of the association by the mapping section. Accordingly, a greater amount of information can be used when software component extraction is performed. As a result, enhancement of the precision of the software component extraction can be expected.

(3) The notifying section notifies an analysis organization of the notification information in a case where the reliability of the notification information is lower than the threshold, and notifies the organization of the software component and the countermeasure information on the basis of change information when the change information has been received from the analysis organization. Accordingly, notification information with low reliability is analyzed by the analysis organization. As a result, it is possible to avoid a problem that, undesirably, information with low reliability is transmitted to a notification-destination organization and analysis in the organization takes extra time.

(4) The notifying section does not notify the analysis organization of the notification information but notifies the organization of the software component and the countermeasure information in a case where the reliability of the notification information is equal to or higher than the threshold. Accordingly, it becomes possible to promptly transmit information with relatively high reliability to a notification-destination organization and reduce time required for implementing a countermeasure.

(5) The information processing apparatus further includes a feedback reflecting section that updates the notification information on the basis of feedback information acquired from the organization. Accordingly, it is possible to cause notification information to reflect correct information finally decided by a notification-destination organization. As a result, enhancement of the precision of analysis thereafter can be expected.

(6) The information processing apparatus includes an alert threat database that stores a type of the alert information and threat information representing information about a threat related to the type, in association with each other, a countermeasure database that stores the threat information and the countermeasure in association with each other, a countermeasure software database that stores the countermeasure and the software component in association with each other, an organization-in-charge database that stores an organization in charge in association with a set of the countermeasure and the software component, and a feedback database that stores the feedback information and change information about the notification information. By including such constituent elements, enhancement of the convenience of the present invention can be expected.

(7) The information processing apparatus further includes a DB updating section that updates the alert threat database, the countermeasure database, the countermeasure software database, the organization-in-charge database, and the feedback database on the basis of the feedback information and the change information. Accordingly, information in each database is updated to correct information. As a result, enhancement of the precision of each process can be expected.

(8) The notifying section notifies the organization of information about a notifier organization of the software component and the countermeasure information. Accordingly, it becomes possible for the organization having received the notification information to analyze the notification information more appropriately by referring to the information about the notifier organization.

Note that the present invention is not limited to the embodiment described above, and various modifications can be made to the present invention. For example, the embodiment described above is explained in detail in order to explain the present invention in an easy-to-understand manner, and the present invention is not necessarily limited to a mode including all the constituent elements explained. In addition, some of the constituent elements of an embodiment can also be replaced with constituent elements of another embodiment. In addition, constituent elements of an embodiment can also be added to the constituent elements of another embodiment. In addition, some of the constituent elements of each embodiment can be deleted, additionally have other constituent elements, or be replaced with other constituent elements.

### DESCRIPTION OF REFERENCE SYMBOLS

1: Information processing apparatus
3: External entity
11: Alert acquiring section
12: Mapping section
13: Component extracting section
14: Notification destination identifying section
15: Reliability setting section
16: Notifying section
17: Feedback reflecting section
18: DB updating section
34: Notification destination
101: Alert threat DB
102: Countermeasure DB
103: Countermeasure software DB
104: Organization-in-charge DB
105: Feedback DB

1.-8. (canceled).

9. An information processing apparatus comprising:
an alert acquiring section that acquires alert information;
a component extracting section that extracts a software component for which a countermeasure is necessary, on a basis of the alert information;
a notification destination identifying section that identifies an organization which is capable of implementing the countermeasure for the software component and that decides notification information of which the organization is to be notified;
a reliability setting section that sets reliability of the notification information;
a notifying section that notifies the organization of the software component in a case where the reliability is equal to or higher than a predetermined threshold; and
a mapping section that associates, with the alert information, threat information representing information about a threat related to the alert information and countermeasure information corresponding to the threat information, wherein
the component extracting section extracts the software component on a basis of a result of the association by the mapping section.

10. The information processing apparatus according to claim 9, wherein
the notifying section notifies an analysis organization of the notification information in a case where the reliability of the notification information is lower than the threshold, and notifies the organization of the software component and the countermeasure information on a basis of change information when the change information has been received from the analysis organization.

11. The information processing apparatus according to claim 10, wherein
the notifying section does not notify the analysis organization of the notification information but notifies the organization of the software component and the countermeasure information in a case where the reliability of the notification information is equal to or higher than the threshold.

12. An information processing apparatus comprising:
an alert acquiring section that acquires alert information;
a component extracting section that extracts a software component for which a countermeasure is necessary, on a basis of the alert information;
a notification destination identifying section that identifies an organization which is capable of implementing the countermeasure for the software component and that decides notification information of which the organization is to be notified;
a reliability setting section that sets reliability of the notification information;
a notifying section that notifies the organization of the software component in a case where the reliability is equal to or higher than a predetermined threshold; and
a feedback reflecting section that updates the notification information on a basis of feedback information acquired from the organization.

13. The information processing apparatus according to claim 12, further comprising:
an alert threat database that stores a type of the alert information and threat information representing information about a threat related to the type, in association with each other;
a countermeasure database that stores the threat information and the countermeasure in association with each other;
a countermeasure software database that stores the countermeasure and the software component in association with each other;
an organization-in-charge database that stores an organization in charge in association with a set of the countermeasure and the software component; and
a feedback database that stores the feedback information and change information about the notification information.

14. The information processing apparatus according to claim 13, further comprising:
a database updating section that updates the alert threat database, the countermeasure database, the countermeasure software database, the organization-in-charge database, and the feedback database on a basis of the feedback information and the change information.

15. The information processing apparatus according to claim 9, wherein
the notifying section notifies the organization of information about a notifier organization of the software component and the countermeasure information.
